(19) United States
(12) Patent Application Publication
(10) Pub. No.: US 2004/0083230 A1
(43) Pub. Date: Apr. 29, 2004

(54) Method and system for automatically managing an address database

(76) Inventor: David A. Caughey, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/278,856

(22) Filed: Oct. 24, 2002

(51) Int. Cl. G06F 7/00

(52) U.S. Cl. 707/104.1

(57) ABSTRACT

An electronic mail server for automatically managing a keep in touch service and method are disclosed. The system is for providing keep in touch, i.e. KIT, electronic messages to a plurality of electronic addresses stored within address books such that when an electronic address is stored in more than one address books, the electronic address is tagged and only one message is sent. The electronic mail server intercepts any response to the KIT, in the form for example of a bounce or a reply, and provides the response to the sending party. When the KIT bounces, the server automatically sends an update request message to all the electronic addresses seeking for a different electronic address for the individual having a non-valid electronic address.

### FIELD OF THE INVENTION

The present invention relates to electronic contact list management and more specifically to a method and system for automatically managing an address database.

### BACKGROUND OF THE INVENTION

In the past, people have maintained contact lists on paper. The proverbial “black book” is a good example of a list of individuals and their contact information. However, the task of maintaining a large contact list on paper often constitutes a formidable undertaking, too onerous for the few times one needs to contact each individual. In the present, with the advent of the Internet, electronic messaging systems are replacing the classical form of a letter, and contact lists are now kept in the form of electronic databases, rather than on paper.

Many electronic messaging systems keep electronic “address books,” which typically include contact information databases, within which records of the mailbox addresses for different users are stored. Some address books also store additional user information, such as telephone numbers, mailing addresses, job titles, and other information that is typically unrelated to electronic messaging. Such an address book is often referred to as a “contact manager,” as a user is capable of using the address book to maintain a wide variety of information about many different people. As the use of electronic messaging has become more widespread, many computer users send and receive more electronic messages to and from a larger number of other computer users.

A service offering automated updating of electronic contact information and ensuring current contact information is offered by GoodContacts® through their World Wide Web site. GoodContacts® addresses the difficult task of enabling people to stay connected to their many circles of contacts. The service provided by GoodContacts® allows for updating and management of personal information relating to contacts, and provides a dynamic link to all personal and professional relationships. The philosophy of GoodContacts® is to “Keep in Touch” (KIT), following a strategy that is based on a system of KIT messaging, but goes beyond the technical aspects as to emphasize the value of continuous business contacts. The main KIT task is performed by providing a method for each member of a KIT system, to transmit to other members requests for information updates, thereby allowing for automatic updating of their contacts within their address book.

Although GoodContacts® KIT service does automate the KIT process, it only provides benefits once an individual's contact data is entered into a contact list. There are times when one does not even realise that an individual is not a member of a certain contact list. For example, when messages are sent out to a predetermined set of contact addresses and one message fails to be delivered, there is no direct updating system for getting the new electronic address of the contact person of whom there was a previous failure delivery.

A natural way to update an address book is to try to contact this person by phone or by fax. For people that entertain a large contact list, this is a serious waste of time, and unfortunately, such an update is often not performed. If such a loss is an occasional phenomenon, it is easily manageable, and depending on the importance of the contact lost, it is worthwhile to take the time to find the new contact information. Of course, there is a higher risk of potential loss of contact information with a larger number of contacts. Consequently, the time and expense involved in updating the contact list increases as the number of contacts increase.

In order to overcome such drawbacks of the prior art, it would be advantageous to provide users with a system capable of keeping in touch with every contact contained within a contact list, regardless of changes in the corresponding electronic contact addresses.

### OBJECT OF THE INVENTION

It is an object of this invention to provide an automatically updated electronic address book that requires a minimum of intervention from a user.

### SUMMARY OF THE INVENTION

In accordance with an aspect of instant invention, there is provided a method for automatically updating electronic address data, which comprises a step of receiving an update request message on a second computer. The update request message is received from a first computer and contains personal data relating to an individual for whom a failed electronic address is known. The failed electronic address results in a failure delivery notice upon an attempt to send an electronic message to the failed electronic address. The method further comprises the steps of comparing the personal data with personal data contained within an address book stored on the second computer, with the second computer automatically generating a response; and automatically sending the response.

In accordance with an aspect of instant invention there is further provided a method for automatically updating electronic address data, which includes receiving on an electronic mail server an automatic reply to a keep in touch message sent from a first computer to an address data on a second computer. In case that the reply message indicates that the keep in touch message bounces, the address data are automatically tagged; and further electronic mail messages to be transmitted to the tagged address data are intercepted.

In accordance with an aspect of the instant invention there is further provided an electronic mail server supporting a plurality of computers. The mail server comprises a memory storage medium for storing a plurality of address books for storing address data therein, a processor for receiving a plurality of reply messages in response to a keep in touch message sent from a first computer to the address data, and a contact processor for processing the reply messages.

In accordance with another aspect of the instant invention there is provided a method for automatically updating electronic address data, which comprises the steps of transmitting from at least a computer a keep in touch electronic message to a plurality of address data stored within a plurality of address books, and comparing the plurality of address data within the plurality of address books. When a result of the comparison indicates that at least one identical address data is stored within other than one address book, the identical address data is automatically tagged within the other than one address book where the at least one identical address data is stored, and the keep in touch message is provided to the plurality of address data, and to one of the identical address data.

In accordance with another aspect of the instant invention there is further provided an electronic mail server comprising a memory storage medium for storing a plurality of address books for storing address data therein, a processor for generating a keep in touch message and for sending the keep in touch message to the plurality of address data stored within the plurality of address books, a contact coordinator for comparing the address data from the plurality of address books to which the keep in touch message is to be sent such that when an address data associated to an individual appears within other than one address book from the plurality of address books, the address data associated to the individual is tagged, and a gate for filtering the tagged identical address data associated to the individual such that the keep in touch message is sent once to the individual.

### BRIEF DESCRIPTION OF THE DRAWINGS

Exemplary embodiments of the invention covering the aspect of a “Keep in Touch” (KIT) system will now be described in conjunction with the following drawings, in which:

FIG. 1 is a block diagram of an electronic mail server for automatically providing KIT messages;

FIG. 2a is a block diagram of an electronic mail server for managing KIT messages for a plurality of computers in communication with the mail server;

FIG. 2b is a block diagram of an electronic mail server for reacting when the KIT message bounces when a plurality of computers are in communication with the coordinator;

FIG. 3 is a flow chart diagram of a method of reacting when the KIT message bounces;

FIG. 4a is a flow chart diagram of a method of managing a KIT messaging system;

FIG. 4b is a flow chart diagram of another method of managing a KIT messaging system;

FIG. 4c is a flow chart diagram of a further method of managing a KIT messaging system;

FIG. 5a is a flow chart diagram of a method of managing a reply message to a KIT message;

FIG. 5b is a flow chart diagram of another method of managing a reply message to a KIT message;

FIG. 6 is a flow chart diagram of a method of reacting when the KIT message bounces and when a plurality of computers is in communication with the electronic mail server; and,

FIG. 7 is a flow chart diagram of another method of reacting when the KIT message bounces and when a plurality of computers is in communication with the electronic mail server.

### DETAILED DESCRIPTION OF THE INVENTION

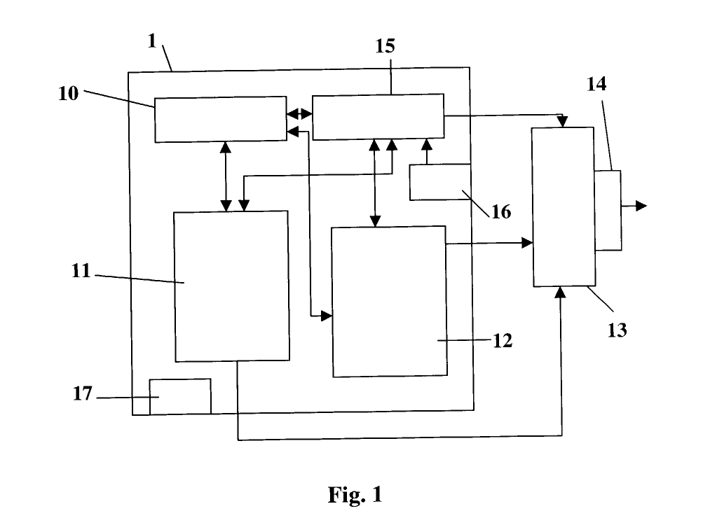

In the following, “Keep in Touch” (KIT) systems for automatically managing an address database according to the present invention will be described in detail. Referring to FIG. 1, an electronic mail server for automatically providing KIT messages according to a first embodiment of the present invention is shown. The electronic mail server 1 includes e-mail software 10 in communication with a plurality of contact addresses grouped in various address books such as, for example, business address book 11 containing a set of business contact addresses, and personal address book 12 containing contact addresses of individuals in private relationship of a user. The business address book 11 and personal address book 12 are also in communication with KIT software 13. The KIT software 13 includes a gate 14 for allowing KIT messages to be sent. Furthermore, the electronic mail software 10, the business address book 11 and personal address book 12 are in communication with a contact coordinator 15, which in turn is in contact with the gate 14.

A KIT message is an electronic message, also referred to as e-mail message, which is sent to a contact address contained within an address book of a messaging system. The KIT message is for ensuring that the address book contains updated electronic addresses for directing electronic messages thereto. A KIT messaging system is particularly useful if it regularly sends KIT messages to each contact within address books. The period of time lasting between two successive sent KIT messages is chosen as to minimize both the risk of unnoticed address changes on one hand, and customer annoyance due to multiply received KIT messages on the other hand.

In operation, the e-mail software 10 generates a KIT message for transmission to addresses of each individual registered in the business address book 11, as well as in the personal address book 12. The contact coordinator 15 is notified of such KIT messages being generated, and communicates with the gate 14 for allowing the KIT messages to be sent to the business and personal contacts. The KIT software 13 extracts the corresponding address data from business and personal address books 11 and 12, and a KIT message is sent to each of the extracted address data in dependence upon instructions received from the contact coordinator 15. Advantageously, the contact coordinator 15 detects when address data for a same individual is contained within both the business and the personal address book. The contact coordinator 15 avoids sending the same KIT message twice, retaining multiple messages to the same address at the level of the gate 14. Thus, an individual whose address data is contained within more than on address book does not repeatedly receive a same KIT message, cutting down the amount of possibly annoying email messages received.

Optionally, the mail server 1 includes a clock 16 for providing a time indication to the coordinator 15. The contact coordinator 15 tags the address data with a value indicative of the time and/or date at which a KIT message was transmitted.

Besides the above-mentioned case that at a given time a KIT message is sent to the addresses of more than one contact book, there exist various other possibilities for sending redundant KIT messages to a same electronic address. For example, when KIT messages for all members of a certain address book are sent at different times for different address books, a contact whose name is present in more than one address book, is likely to repeatedly receive a same KIT. In order to avoid this, the contact coordinator 15 tags address data, and compares new KIT messages with previous KIT messages to ensure that duplicated KIT messages are not transmitted. The tagged address data is stored in memory for a predetermined length of time. At the end of this period of time a log-file is created indicating the time and related information regarding the KIT message, and the address data is erased from memory. Alternatively, no logfile is created.

Advantageously, outgoing electronic KIT messages are transmitted at night when the activities of other users of a central mail system are likely reduced. A KIT operation performed at night or during the weekends is not likely to interfere with other user requests to the e-mail server. Further, depending on the size of the address books, the contact coordinator 15 distributes the KIT messages in blocks at a time, for example a first block containing the first 200 addresses, a second block contain the next 200 addresses, and so forth, in order to avoid interferences with the normal load capacity of the mail server.

Further advantageously, the process of time stamping a KIT message is used to prevent that another KIT message is prematurely sent to a same electronic address. Optionally, the email server includes a memory 17 for storing tagged address data for a period of time corresponding to the minimum amount of time, after which a second consecutive KIT message is allowed to be sent to a same electronic address. Therefore, when a KIT message is generated and sent to individuals whose electronic contact address is stored within the business book 11, the contact coordinator 15 tags and stores the address data. When a same KIT message at a later time is generated and sent to the individuals whose address stored is within the personal book 12, the contact coordinator 15 compares the tagged address data stored with the new address data to which the KIT message is directed. When address data for a same individual is contained within personal book and in the memory, the contact coordinator 15 filters the address data such that the KIT message is not sent to this address data.

Of course, when a manual override to allow a forced KIT transmission is supported, a KIT message is transmitted, and newly tagged address data overwrites older tagged address data. Alternatively, when a KIT message has been sent to all the different contacts contained within the address books, an indication of the date the last KIT message was sent is stored, and the memory is cleared.

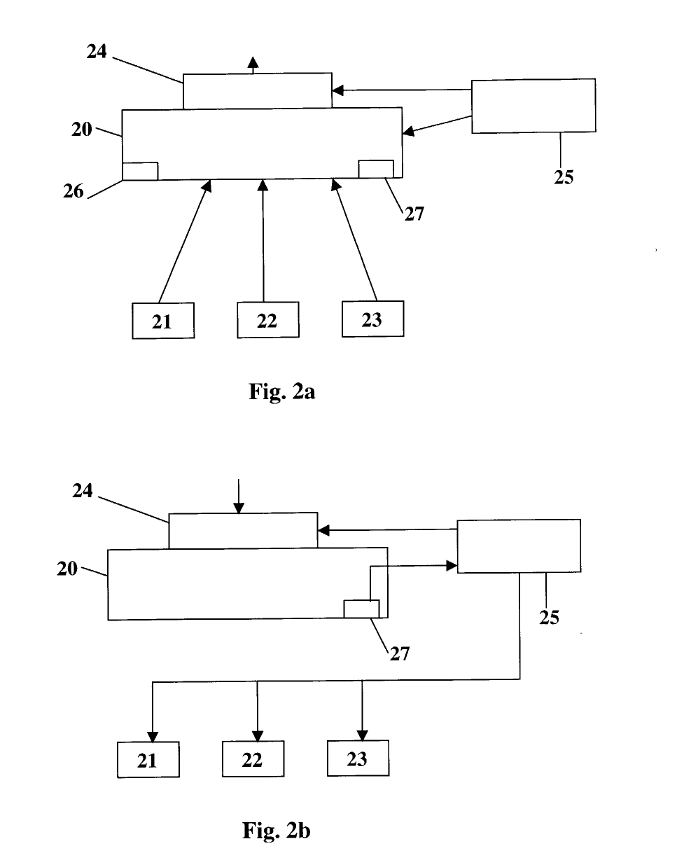

Referring now to FIG. 2a, an electronic mail server for managing KIT messages for a plurality of computers in communication with the mail server is shown. Three computers 21, 22, and 23 are in communication with the electronic mail server 20. The electronic mail server 20 includes a gate in the form of a filter 24 for allowing KIT messages to be transmitted. A contact coordinator 25 is in communication with the electronic mail server 20 and the filter 24.

In operation, the computers 21, 22, and 23 provide a request to the electronic mail server 20 to send out a KIT message to the address data contained within their respective address book. The contact coordinator 25 extracts the address data and compares the address data from each address book, such that if the address data of an individual appears in more than one address book, only one message is sent to the address data. This way, a given individual receives only one KIT message.

A KIT message, whose recipient address data is present in a plurality of address books, preferably includes data indicative of each of the corresponding address books. For example, if Joe is the user of computer 21 and John is the user of computer 22, and both Joe and John send a KIT message to Bob, whose identical address data bob.smith@xyz.com is contained within both Joe's and John's address book, then the contact coordinator 25 is alerted prior to the messages being sent. The contact coordinator 25 compares Joe's and John's address books and finds out that both contain address data bob.smith@xyz.com associated with the same individual Bob. The contact coordinator 25 composes one single KIT message, which is sent to bob.smith@xyz.com, the message indicating that both Joe and John want to “Keep in Touch” with Bob.

Optionally, the electronic mail server 20 includes a clock 26 for providing time indication to the coordinator 25 such that the coordinator tags the address data, to which a KIT message was sent, with a time stamp.

Optionally, the email server includes a memory 27 for storing tagged address data for a period of time elapsing between two consecutive KIT messages are sent. Therefore, when a KIT message is generated and sent to the address data contained within the address book of computer 21, the coordinator tags the address data, and the tagged address data is stored in the memory 27. When the KIT message is generated and sent at a later time to the address data contained within the address book of computer 22, the coordinator compares the tagged address data stored with the new address data to which the KIT message is directed. When address data for a same individual is contained within the address book of computer 22 and in the memory 27, the coordinator filters the address data such that the KIT message is not sent to this address data. The coordinator tags the address data extracted from address book of computer 22, and the tagged address data are saved within the memory 27 along with the tagged address data extracted from the address book of computer 21. In the a same way, when the KIT message is generated and sent at a further time to the address data contained within the address book of computer 23, the coordinator compares the tagged address data stored with the new address data the KIT message is directed to. When address data for a same individual is contained within the address book of computer 22 and in the memory 27, the coordinator filters the address data such that the KIT message is not sent to this address data. The coordinator tags the address data extracted from address book of computer 22 and the tagged address data are saved within the memory 27 along with the tagged address data extracted from the address book of computer 21.

Of course, an address data newly tagged overwrites an older corresponding tagged address data to prevent overloading the memory. Alternatively, when a KIT message has been sent to all the address data contained within the address books, the memory is cleared, and an indication of the date the last KIT message was sent is stored.

Referring now to FIG. 2b, a block diagram of an electronic mail server is shown, the electronic mail server reacting to a bounced KIT message. The electronic mail server 20 includes a gate in a form of a filter 24 and a memory 27, both in communication with a contact coordinator 25. A plurality of computers 21, 22 and 23 are in communication with the coordinator 25.

In operation, when a KIT message bounces, the filter 24 communicates the address data to which the KIT message was originally sent to the contact coordinator 25. The contact coordinator consults the memory 27 to determine which of the three computers 21, 22 and 23 contains address data, to which the KIT message was originally sent such that a notification is addressed to the appropriate computers.

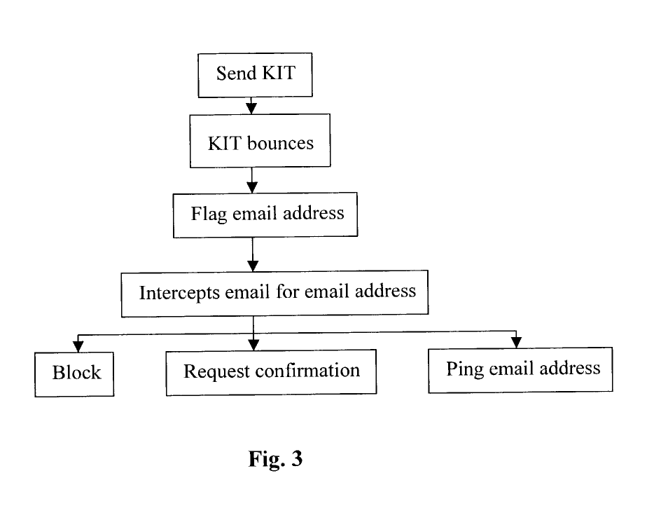

Referring to FIG. 3, shown is a flow chart diagram of a method of reacting when a KIT message bounces. When an electronic mail server generates a KIT message and sends the KIT message to a plurality of contact address data, a possibility exists that a contact address data is no longer valid. When this is the case, the KIT sent to this address data will return with a notice indicating that the KIT has not been delivered. Henceforth, this action is referred to as a “bounce”. Upon receiving a bounced KIT, the electronic mail server flags the address data in order to intercept further electronic mail message sent to the flagged address data.

A plurality of options is available for reacting when another electronic message is to be sent to a flagged address data. One option is to block other electronic messages sent to this address data. When a message is blocked, the sending party is notified that the address data to which the further electronic message is directed is no longer valid. Alternatively, the server requests confirmation that the user wishes to send the electronic message to the flagged address data. Another option is to ping the address data before sending the further electronic message. This alternative is beneficial for electronic messaging system in which the electronic mail server limits the size of the messages; i.e. under the limit, the transmission of the message is free of charge, and over the limit, the transmission is chargeable. Therefore it is important to the user that the address data be validated before sending a large electronic message.

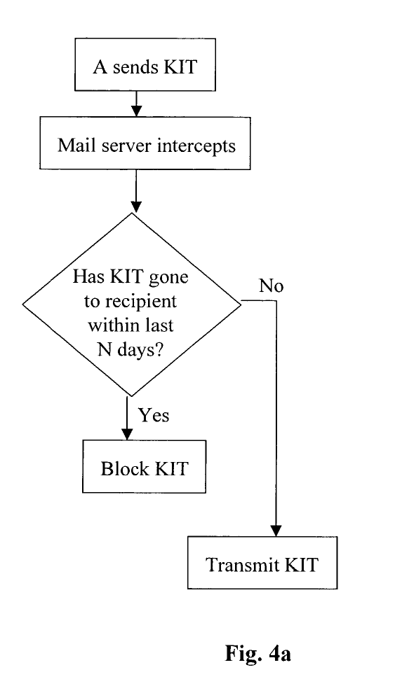

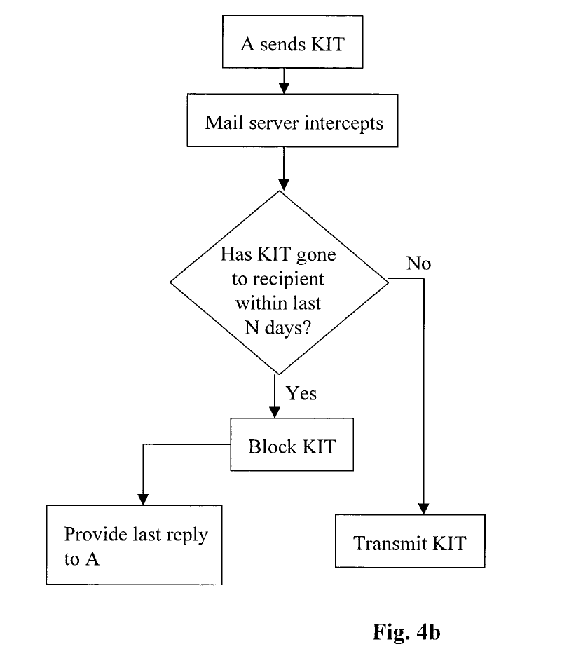

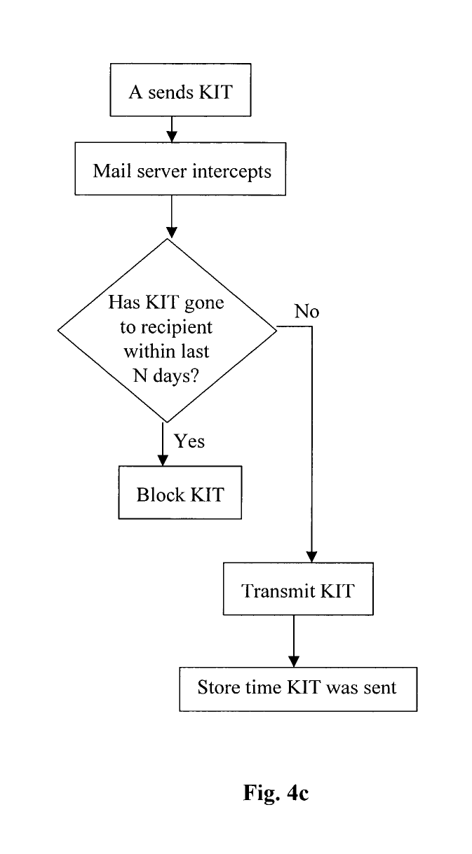

Referring to FIG. 4a a flow chart diagram of a method of managing a KIT messaging system is shown. When a computer A in communication with an electronic mail server generates and sends a KIT message to the address data stored within the address book of the computer A, the electronic mail server intercepts the KIT messages. The electronic mail server extracts from storage memory information stored therein, the information indicative of at least a date the computer A sent the last KIT. When the extracted information indicates that the last KIT was sent within a predetermined time frame, the server retains the KIT to avoid sending KIT messages too often to the same address data. When the extracted information indicates that the last KIT was sent outside the predetermined time frame, the KIT is transmitted to the address data stored within the address book of computer A. Preferably, the server is set up as to provide electronic messaging to any number of computers and manages the KIT messages sent by computers that it serves as previously described.

Optionally, as shown in FIG. 4b, when the extracted information indicates that the last KIT was sent within a predetermined period of time, the server does not send the KIT to avoid providing a redundant KIT to the same address data. The server then retrieves the last reply received after the last KIT was sent and provides the last reply to computer A.

Further optionally, as shown in FIG. 4c, when the extracted information indicates that the last KIT was sent outside a predetermined period of time, a new KIT is transmitted to the address data stored within the address book of computer A. The server stores within a memory an indication of a time and a date the new KIT was sent from computer A, for determining a new time frame and preventing a future KIT from being sent within the new predetermined time frame.

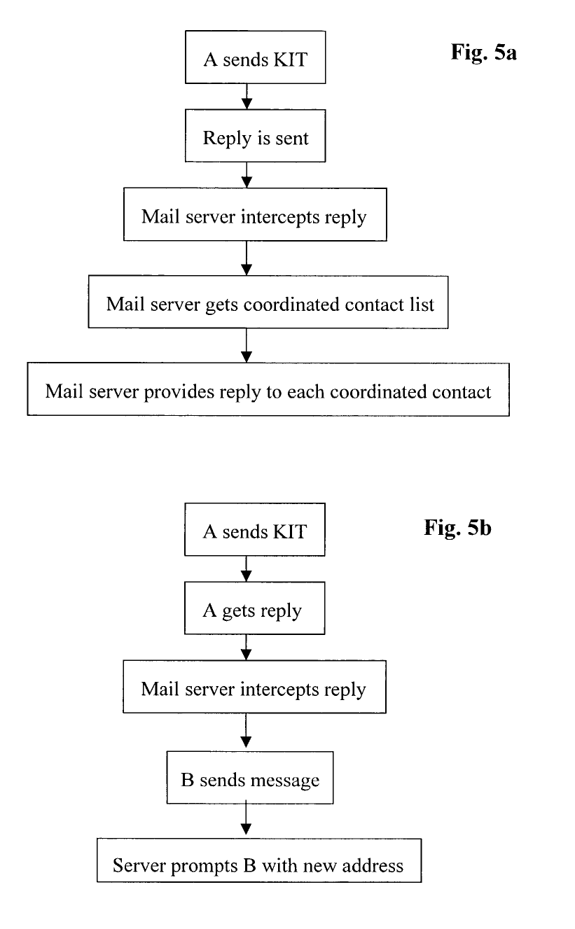

When an electronic mail server generates a KIT message and sends the KIT message to a plurality of contact address data, the electronic mail server typically receives a reply message from the various address data to which the KIT was sent. A method of managing a reply message to a KIT message is shown in FIG. 5a in form of a flow chart diagram. A computer A in communication with an electronic mail server generates and sends a KIT message to a recipient corresponding to address data stored within an address book of computer A. Typically, computer A gets reply messages from a recipient to which the KIT message was sent. A reply message is for example acknowledgment message indicating to the KIT sending party successful delivery of the KIT message, validation of the e-mail address, and possibly an intention to keep in touch with the KIT sending party, namely the user of computer A. As another possibility, the contacted party prefers to have his or her entry removed from the address books associated with computer A.

The mail server intercepts the reply message, regardless of the content of the reply. According to the KIT system architecture as illustrated in FIGS. 1 and 2, the server extracts a coordinated contact list, relating to a contact to which the KIT was sent. The mail server scans all the address books related to computers in contact with the mail server, and performs certain actions on the all the address books having as an entry the recipient of the KIT message, according to instructions provided by the reply message intercepted by the mail server. A modification of the address books for example includes an update of the electronic mail address, besides other possible changes. This way, not only the address book associated with computer A is updated, but all other address books are automatically updated as well.

There exist a possibility that a user B of a certain computer prefers that his address book is not updated as the result of a reply to a KIT message sent out by another user A. Referring now to FIG. 5b, shown is a flow chart diagram of a method for individual responses to a received reply to a KIT message. User A sends out a KIT message to a contact Q, and a response to that KIT message is intercepted by the mail server. The mail server analyses the response, which for example contains a change of the e-mail address, and forwards an appropriate reply regarding changed information of contact Q to the user A. Preferably, the mail server automatically updates the address book of user A as to incorporate the changes in contact information of contact Q. Instead of automatically updating an address book of user B, which also contains information regarding contact Q, an appropriate note that the contact information of Q has changes is stored with the central mail server. In a next step, user B sends out a message to the contact Q. The mail server intercepts the outgoing messages, analyzes the address, and by comparison with stored information realizes that the address for contact Q is no longer valid. At this point, the mail server informs user B, and prompts for appropriate action. For example, the message sent by user B is forwarded to the new address of contact Q, or the message sent by user B is cancelled. Optionally, the mail server prompts user B whether her or his address book is to be updated.

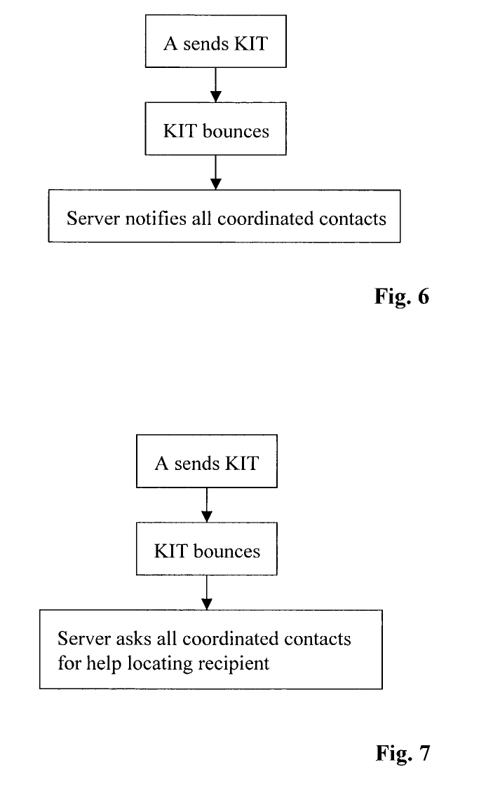

Referring to FIG. 6, a flow chart diagram of a method of reacting when a KIT message bounces is shown. The method supports an electronic mail server in communication with a plurality of computers. When an electronic mail server generates a KIT message and sends the KIT message to the individuals, whose address data are stored within a plurality of address books from a plurality of computers, a possibility exists that an address data common to more than one address book is no longer valid. When this is the case, the KIT sent to this address data bounces. Upon receiving a bounced KIT, the electronic mail server communicates with the contact coordinator such that the coordinator retrieves the address books including the address data for which the KIT bounced. The relevant address books are notified of the invalid address data.

Referring to FIG. 7, a flow chart diagram of a method of reacting when the KIT message bounces is shown. This method is intended to enhance the likelihood of determining a new, valid address data when a KIT bounces. A mail server supports electronic messaging for a plurality of computers. Each of the computers stores their own address data separately. For example, a user A sets up a KIT message for a contact address Q contained in the address book associated with A's computer. The server sends a KIT message to the contact address Q. When the contact address Q is not longer valid, the KIT messages bounces, and is returned to the server. The server generates a help message, which is sent to all of the computers supported by the server. An electronic help message includes the last known address data of the individual. To prevent any confusion between a plurality of individuals having similar address data, the electronic help message includes further information associated with the individual such as full surname, full first name, and so forth. The help message is for determining if any of the supported computers have a different address data available for that individual.

Various results of the comparison between the personal data contained within the request message for an update of the address data of the individual and the personal data stored within address books of other computers are possible. A first result is that an available address data different from the address data for which a KIT bounces, is stored within at least one address book of a supported computer. When such is the case, the computer having the different available address data within its address book automatically sends a reply message to the electronic mail server to notify the server of such, and to provide the server with the different address data for the individual. Alternatively, in order to preserve the privacy of an individual, the computer having the different address data within its address book automatically forwards the help message to the different address data associated with the individual to notify the individual that a request for help message has been received from the electronic mail server; the server having received a KIT bounce during a routine keep in touch operation. Of course depending on a reply of the individual to the help message forwarded, the different address data for the individual is one of provided to the electronic mail server and other than provided to the server.

A further result is that no address data different from the address data for which a KIT bounces is found in any of the address books with which the contact coordinator is in communication. When this occurs, the user using the computers wherein the address data for which the KIT bounces are notified that the address data is no longer valid and that a manual update is required.

There is no limitation regarding the number of KIT bounces received by the electronic mail server. However, a KIT message is regularly sent in order to limit the number of KIT bounces each time a KIT is sent.

Numerous other embodiments may be envisaged without departing from the spirit or scope of the invention.

What is claimed is:

1. A method for automatically updating electronic address data comprising the steps of:
receiving an update request message on a second computer, the update request message received from a first computer and containing personal data relating to an individual for whom a failed electronic address is known, the failed electronic address resulting in a failure delivery notice upon an attempt to send an electronic message to the failed electronic address;
comparing the personal data with personal data contained within an address book stored on the second computer;
automatically, with the second computer, generating a response; and
automatically sending the response.

2. A method for automatically updating electronic address data according to claim 1 wherein the step of automatically, with the second computer, generating a response comprises the step of:
automatically, with the second computer, generating a forward message to the individual indicating that a user of the first computer is seeking updated personal data regarding the individual, the forward message to be sent via a communication network

3. A method for automatically updating electronic address data according to claim 2 comprising the steps of:
receiving the forward message on the first computer; and
automatically storing the updated personal data within a memory storage medium for further retrieval.

4. A method for automatically updating electronic address data according to claim 3, comprising the step of automatically replacing the personal data relating to an individual for whom a failed electronic address is known with the updated personal data contained within the forward message.

5. A method for automatically updating electronic address data according to claim 1, wherein the step of automatically, with the second computer, generating a response comprises the step of:
automatically, with the second computer, generating a reply message to the update request message, the reply message including different address data for the individual when a result of the comparison indicates that the address book contains different address data for the individual, the reply message to be sent to the first computer

6. A method for automatically updating electronic address data according to claim 5 comprising the steps of:
receiving the reply message on the first computer; and
automatically storing the different address data included in the reply message within the address book of the first computer.

7. A method for automatically updating electronic address data according to claim 6 comprising the step of automatically replacing the failed electronic address with the different address data included in the reply message within the address book of the first computer.

8. A method for automatically updating electronic address data according to claim 1, wherein the step of receiving an update request message comprises the step of:
receiving a request for help message including personal information to identify an individual associated with a no longer valid address data, the request for help message for determining whether a different address data associated with the individual is available,
wherein a contact coordinator compares the personal information with personal information associated with the stored address data; and,
forwarding the request for help message to a different address data when the comparison indicates that different address data associated with the individual is available.

9. A method for automatically updating electronic address data comprising the steps of:
receiving on an electronic mail server an automatic reply to a keep in touch message sent from a first computer to an address data on a second computer, the reply message indicating that the keep in touch message bounces;
automatically tagging the address data; and
intercepting further electronic mail message to be transmitted to the tagged address data.

10. A method for automatically updating electronic address data according to claim 9 wherein the step of intercepting further electronic mail message to be transmitted to the tagged address data comprises the step of blocking the further electronic mail message.

11. A method for automatically updating electronic address data according to claim 10 wherein the step of intercepting further electronic mail message to be transmitted to the tagged address data comprises the step of requesting confirmation of the address data before sending the further electronic mail message.

12. A method for automatically updating electronic address data according to claim 10 wherein the step of intercepting further electronic mail message to be transmitted to the tagged address data comprises the step of pinging the address data before sending the further electronic mail message.

13. An electronic mail server supporting a plurality of computers, comprising:
a memory storage medium for storing a plurality of address books for storing address data therein;
a processor for receiving a plurality of reply messages in response to a keep in touch message sent from a first computer to the address data; and
a contact processor for processing the reply messages.

14. An electronic mail server supporting a plurality of computers according to claim 13, wherein the contact processor comprises:
a contact coordinator for extracting from the memory storage medium the address data in the plurality of address books to which the keep in touch message was sent to identify address data stored in more than one address books; and,
a second processor for providing the reply messages received from each address data to the address books where the address data is stored;
wherein when an address data has been identified to be stored in more than one address books, the reply message is provided to each address data stored in the more than one address books.

15. An electronic mail server supporting a plurality of computers according to claim 14, wherein the reply message includes a bounced keep in touch message.

16. An electronic mail server supporting a plurality of computers according to claim 13, wherein the contact processor comprises:
a second processor for automatically generating and sending a request for help message when at least one reply message indicates that the keep in touch message was sent to an address data no longer valid, the help message sent to the address data other than no longer valid address data.

17. An electronic mail server supporting a plurality of computers according to claim 16, wherein the request for help message comprises:
personal information to identify an individual associated with the no longer valid address data, the request for help message for determining whether a different address data associated with the individual is available in at least an address book.

18. An electronic mail server supporting a plurality of computers according to claim 13, wherein the processor for receiving a plurality of reply messages comprises a processor for receiving a request for help message including personal information to identify an individual associated with a no longer valid address data, the request for help message for determining whether a different address data associated with the individual is available; and,
wherein the contact processor compares the personal information with personal information associated with the stored address data forwards the request for help message to the different address data when the comparison indicates that different address data associated with the individual is available.

19. A method for automatically updating electronic address data comprising the steps of:
transmitting from at least a computer a keep in touch electronic message to a plurality of address data stored within a plurality of address books;
comparing the plurality of address data within the plurality of address books;
when a result of the comparison indicates that at least one identical address data is stored within other than one address book, automatically tagging the identical address data within the other than one address book where the at least one identical address data is stored; and,
providing the keep in touch message to the plurality of address data and to one of the identical address data.

20. A method for automatically updating electronic address data according to claim 19 comprising the step of inserting a time value indicative of at least one of a time and date where the keep in touch electronic message was transmitted from the at least one computer.

21. A method for automatically updating electronic address data according to claim 20 comprising the steps of:
storing the time value for determining a time frame; and,
preventing a further keep in touch message to be transmitted to the plurality of address data stored within the plurality of address books when the time value indicates that the further keep in touch message is to be transmitted within the determined time frame.

22. A method for automatically updating electronic address data according to claim 21 comprising the steps of:
when the time value indicates that the further keep in touch message is to be transmitted outside the determined time frame, transmitting the further keep in touch message;
erasing the time value; and,
storing a new time value indicative of at least one of a time and date when the further keep in touch electronic message was transmitted from the at least one computer.

23. An electronic mail server comprising:
a memory storage medium for storing a plurality of address books for storing address data therein;
a processor for generating a keep in touch message and for sending the keep in touch message to the plurality of address data stored within the plurality of address books;
a contact coordinator for comparing the address data from the plurality of address books to which the keep in touch message is to be sent such that when an address data associated to an individual appears within other than one address book from the plurality of address books, the address data associated to the individual is tagged; and,
a gate for filtering the tagged identical address data associated to the individual such that the keep in touch message is sent once to the individual.

24. An electronic mail server according to claim 23 comprising a clock for providing at least one of a time and date value indicative of at least one of the time and date when a keep in touch message was sent.
